(19) United States
(12) Patent Application Publication
(10) Pub. No.: US 2014/0317138 A1
(43) Pub. Date: Oct. 23, 2014

(54) METHOD OF FACILITATING MANIPULATION OF A DATABASE QUERY

(71) Applicant: PYRAMID ANALYTICS BV, Amsterdam (NL)

(72) Inventors: Avi Perez, New Haven, CT (US); Herbert Ochtman, Hamden, CT (US); Omri Kohl, Tel Aviv (IL)

(21) Appl. No.: 13/807,926

(22) PCT Filed: Dec. 17, 2012
(86) PCT No.: PCT/IB2012/057360

§ 371 Date: Jan. 1, 2013

Related U.S. Application Data
(60) Provisional application No. 61/570,853, filed on Dec. 15, 2011.

(51) Int. Cl. G06F 17/30

(52) U.S. Cl. CPC G06F 17/30967
USPC 707/766

(57) ABSTRACT

A user of a computer system is presented an initial presentation of a database query. The query has two or more dimensions, each of which includes two or more elements, and data corresponding to n-tuples of the elements. A selection is received from the user of one or more sets of elements of one of the dimension to transform into (a) (respective) parameter(s). One or more instructions are received from the user to modify the presentation, with each instruction being confined to providing an instance of the active value of a respective parameter. The initial presentation is modified in accordance with only that/those instruction(s).

### FIELD AND BACKGROUND OF THE INVENTION

The present invention relates to presentation of a database query and, more particularly, to a method of interaction with the query via a graphical user interface (GUI) that simplifies analysis of the query by a user.

A “database query”, or “query” for short, as understood herein, is a set of data retrieved from a database as a multidimensional dataset. Each datum of the dataset is associated with a particular n-tuple of values of the dimensions. For example, a user of relational database software may request values of sales volumes and revenues for a set of countries and a set of years. The query returned by the software has three dimensions: sales, geographic locations (countries) and dates (years). The coordinates of the n-tuples are discrete values of the dimensions. In this example, the values of “sales” are “volume” and “revenue”, the values of “countries” could be “Belgium” “Netherlands” and “Luxembourg” and the values of “years” could be “2010”, “2011” and “2012”. A typical datum of the query could be a value of “sales volume in Belgium in 2011”, associated with the triplet “volume, Belgium, 2011”.

Typically, the query is displayed by the GUI as a table. Because the GUI is two-dimensional and typical queries have three or more dimensions, the table displays data for several values of each of two of the dimensions and one value of each of the other dimensions. For example, sales volumes could be displayed in a table for all three countries (as the rows of the table) and for all three years (as the columns of the table). More generally, the query can be thought of as a data hypercube whose axes are the dimensions of the query and from which two-dimensional tables are selected for display by cutting the hypercube parallel to its axes. This operation is conventionally called “slicing” the query. As defined herein, for any particular displayed table, the row and column dimensions of the table are “explicit dimensions” of the query as displayed and the other dimension(s) is/are “implicit dimensions” of the query as displayed.

Other methods of displaying a portion of the query are known. For example, sales volumes for a particular year could be displayed as a color-coded map of countries, with each country being colored with a color that indicates its sales volume for that year.

Conventionally, the user interacts directly with the query via the GUI in the following ways:

1. Slicing, as described above.

2. Dicing. The user selects a sub-hypercube of the hypercube for display. In the above example, the sub-cube could be sales volumes for all three countries in the year 2011, displayed as a color coded map. “Dieing” also may rotate the sub-hypercube, to change the displayed dimensions.

3. Drill down/up. Suppose the actual coordinate values of the above examples were months in the years 2010-2012 (36 in all) and the individual provinces of Belgium (eleven, including the Brussels Capital Region as a “province”), Netherlands (twelve) and Luxembourg (treated as a single province) (24 in all). The lowest level table of sales volume or sales revenue would have 24 rows and 36 columns. The lowest-level values of a dimension are called herein the “elements” or the “elemental values” of the dimension. The highest level, table of sales volume or sales revenue would have a single row (“Benelux”) and a single column (“2010-2012”), and the single datum displayed would be the sum of all the sales volumes or the sum of all the sales revenues in the query. “Drilling down” from a higher level means making the table more detailed. For example, the query could be “drilled down” from the highest level table to show data for individual countries or individual provinces or for the three individual years or for the 36 individual months. Going in the other direction, “chilling up” from a low-level table produces a high-level table whose data as displayed are combinations (typically sums) of the data of the low-level table. These combined data are associated with n-tuples of “sets” of elements of the dimensions. For example, one of the n-tuples produced by drilling up from months to years is (Luxembourg, 2010, revenue) in which “2010” is a set whose members are the months January 2010 through December 2010. The elements themselves are special cases of sets with just one member each.

4. Roll-up: Summarize the data along a particular dimension. Drilling up to turn a low-level table into a high-level table is one example of roll-up. The roll-up could also be a function of the elements. For example, if one of the dimensions is “revenue”, with elemental values “sales” and “expenses”, that dimension could be rolled up into “profits”=“sales”−“expenses”.

More sophisticated analyses of queries can be performed, but such analyses conventionally cannot be done just by interacting with the GUI. Such analyses conventionally require the user to write scripts in a database query language such as MDX. Some vendors provide menu-driven wizards for facilitating such analyses, but these wizards, too, must be run by the user separately from the displaying of the query in the GUI.

It would be highly advantageous to have a method, for interacting with a database query directly via a GUI, that supports more sophisticated analyses of the query than are presently supported.

### SUMMARY OF THE INVENTION

According to the present invention there is provided a method of presenting, on a computer system, a database query that has a plurality of dimensions, with each dimension including a plurality of elements, the method including: (a) presenting, to a user of the computer system, an initial presentation of the database query; (b) receiving, from the user, a selection of at least one set of the elements of a first one of the dimensions to transform into a respective parameter that has an active value; (c) receiving, from the user, at least one instruction to modify the presentation of the database query, each instruction being confined to providing an instance of the active value of a respective the parameter; and (d) modifying the initial presentation in accordance with only the at least one instruction, thereby presenting an altered presentation of the database query to the user.

According to the present invention there is provided a computer-readable storage medium having non-transient computer-readable code embodied on the computer-readable storage medium, the computer-readable code for presenting, on a computer system, a database query that has a plurality of dimensions, with each dimension including a plurality of elements, the computer-readable code including: (a) program code for presenting, to a user of the computer system, an initial presentation of the database query; (b) program code for receiving, from the user, a selection of at least one set of the elements of a first one of the dimensions to transform into a respective parameter that has an active value; (c) program code for receiving, from the user, at least one instruction to modify the presentation of the database query, each instruction being confined to providing an instance of the active value of a respective the parameter; and (d) program code for modifying the initial presentation in accordance with only the at least one instruction, thereby presenting an altered presentation of the database query to the user.

The methods of the present invention are methods of presenting a database query on a computer system. The database query has two or more dimensions, each of which includes a plurality of elements. Every n-tuple of the elements has associated with it one datum of the data of the query. For example, in the examples below, the two visible dimensions are location and time, the elements of the two visible dimensions are street addresses (in the hierarchy country>province or state>county >zip code>street address) and days (in the hierarchy year>quarter>month >day) and each (street address, day) pair is associated with one datum. The third dimension, of which only a slice is visible, is “measure”, sliced on the “quantity” element of that dimension.

In the basic method of the invention, a user of the computer system is presented an initial presentation of the database query. The computer system receives from the user a selection of one or more sets of elements of a first one of the dimensions to transform into a respective parameter. Each set may include just one element or may include several elements. For example, in the examples of FIGS. 1-10 below the parameters are years, so the elements of the corresponding sets are the days of those years. In the example of FIGS. 11-14 below the parameters are months, so the elements of the corresponding sets are the days of those months. If the parameters had been days, then each corresponding set would have included only one element. In the example of FIGS. 15-17 below, the parameters are countries, so the elements of the corresponding sets are the street addresses of the zip codes of the counties of the of the provinces or states of those countries. Each parameter has a respective active value. The computer system receives from the user one or more instructions to modify the presentation of the database query. The entire contents of each instruction is a new instance of the active value of one of the parameters. No other instructions, not even the slicing, dicing, drilling, rolling-up and pivoting instructions discussed above, are included among the instructions received from the user at this point. The computer system then modifies the initial presentation of the database query in accordance with the instructions, and only in accordance with the instructions.

Preferably, as in the examples below, the user interacts with the computer system via a GUI. The initial and modified presentations are presented on the GUI. The user selection(s) and instruction(s) are received via the GUI.

The parametrized dimension could be any dimension of the database query: an is explicit dimension of the database query (corresponding to a row dimension or to a column dimension of a tabular presentation of the database query) or an implicit dimension of the database query.

Optionally, before the instruction(s) is/are received from the user, a function is received from the user, typically in the form of a script in a language such as MDX, to use to modify the presentation of the database query. The function is a function of, inter alia, the parameters that the user has defined. The modification of the initial presentation of the database query is in accordance with the output of the function. The function may produce its output at least in part by operating on data associated with n-tuples that include elements of (some or all of) the set(s) that were selected for parameterization. For example, in the example of FIGS. 6-8 below, the function is growth percentage of “quantity” (the data) from one year to another. Additionally or alternatively, the output of the function may include another set of elements of one of the dimensions, typically the same dimension as the one for which element sets have been parametrized. For example, in the example of FIGS. 9-14 below, the function is a range-of-months function whose output is all the months from the initial month (first input parameter value) through the final month (second input parameter value)

The scope of the invention also includes a computer-readable storage medium bearing non-transient computer-readable code for implementing the invention.

### BRIEF DESCRIPTION OF THE DRAWINGS

Various embodiments are herein described, by way of example only, with reference to the accompanying drawings, wherein:

FIG. 1 shows a first exemplary database query;

FIG. 2 shows the creation of a “year” parameter for the first exemplary database query;

FIG. 3 shows the first exemplary database query after parameterization;

FIG. 4 shows the display of the first exemplary database query after the creation of a second “year” parameter;

FIG. 5 shows the first exemplary database query following a change of the active value of the first parameter;

FIG. 6 shows a script for calculating growth percentages of the data of the table of FIG. 5;

FIG. 7 shows the results of executing the script of FIG. 6

FIG. 8 shows the table of FIG. 7 following a change of the active value of the first parameter;

FIG. 9 shows the table of FIG. 3 after drilling down to the months of 2008;

FIG. 10 shows the table of FIG. 9 following a change of the active value of the parameter;

FIG. 11 shows the creation of a “month” parameter for the first exemplary database query;

FIG. 12 shows the table of FIG. 11 after the creation of a second “year” parameter;

FIG. 13 shows a script for displaying a range of monthly values;

FIG. 14 shows the table of FIG. 12 following the association of the script of FIG. 13 with the table of FIG. 12 and following changes in the active values of the parameters;

FIG. 15 shows a second exemplary database query;

FIG. 16 shows the display of the second exemplary database query after the creation of a “country” parameter that induces a display of data on the level of “states”;

FIG. 17 shows the table of FIG. 16 following a change of the active value of the parameter;

FIG. 18 is a high-level partial block diagram of a computer system for implementing the method of the present invention.

### DESCRIPTION OF THE PREFERRED EMBODIMENTS

The principles and operation of presentation of a database query using a GUI according to the present invention may be better understood with reference to the drawings and the accompanying description.

Conventionally, the elements and the element sets of a database query, as displayed by database management software at a GUI, are static values. The basic innovation of the present invention is to modify the database management software to functionalize the display of the database query by the GUI. The database management software is modified so that the elements and the element sets of a database query can be transformed into parameters of the database query such that values of the parameters can be changed merely by using the GUI to edit those values. The database query as displayed, now being a function of the parameters, changes automatically in response to the change in the parameter values. As will be seen below, the conventional way to accomplish these changes is, in simple cases, to use the conventional manipulations of the query as discussed above, and, in complex cases, to write a special script or to invoke a wizard.

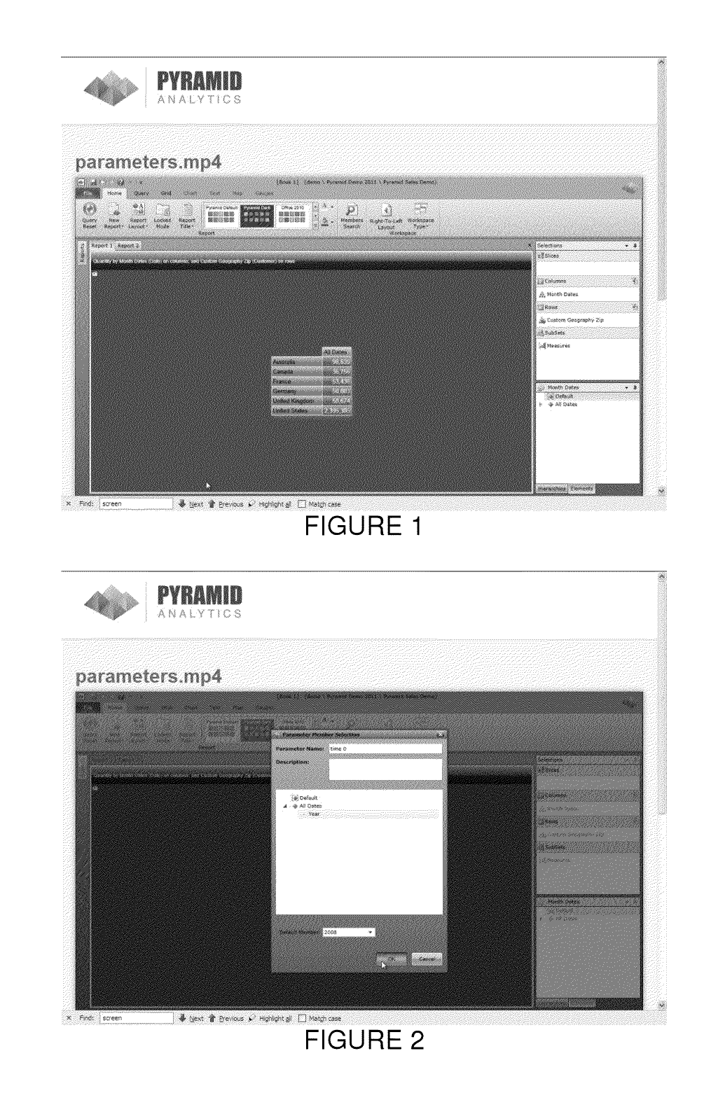

Referring now to the drawings, FIG. 1 shows a simple example of a query as displayed as a table by a GUI. In this query, the row dimension is “location” and the column dimension is “time”. The elements of the row dimension are street addresses, grouped (from the hierarchy “country>province or state>county>zip code>street address”) into sets on the level of countries. The elements of the column dimension are days, grouped (from the hierarchy “year>quarter>month 22 day”) into sets on the level of the years 2008-2010. The displayed data are “quantities”.

In FIG. 2, a column element set parameter of type “year” is created, with the default value “2008”.

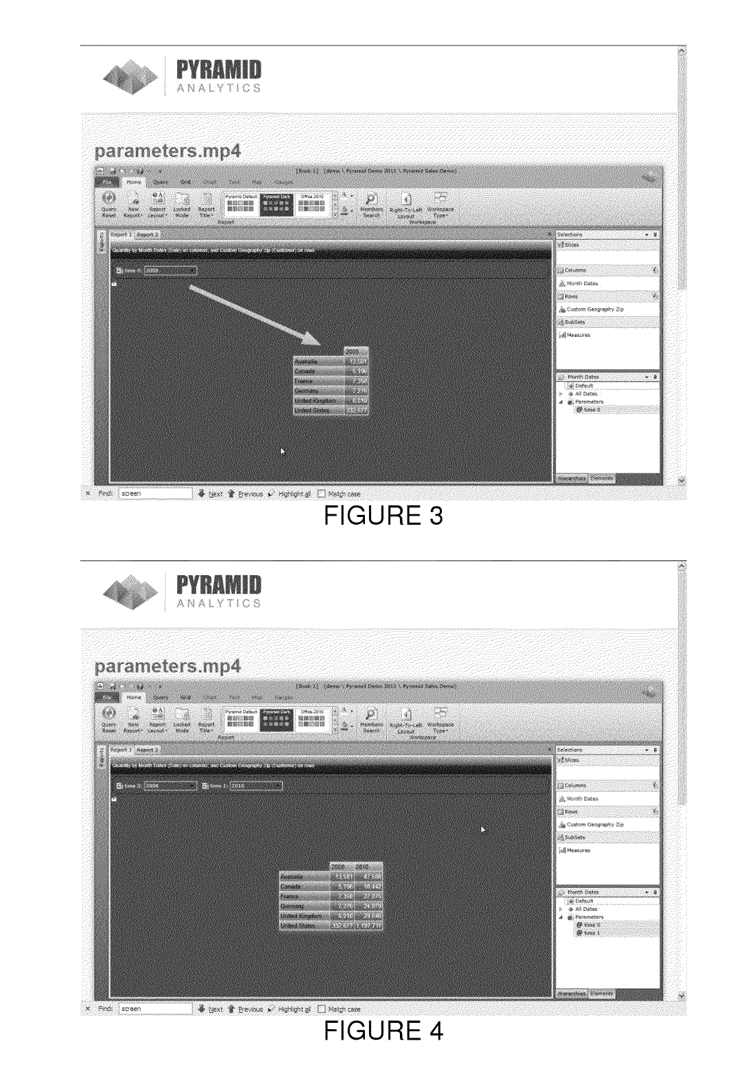

FIG. 3 shows the results of this parameterization, which has adjusted the query selection on the column axis. The single column of the table now shows the data for the default year 2008. A box in the upper left-hand corner of the screen shows the parameter (“time 0”) and its active value (“2008”). Initially upon creation of a parameter, the active value of the parameter is equal to its default value.

FIG. 4 shows the GUI display after the creation of a second “year” parameter (“time 1”) with the default value “2010”. The two parameterizations have adjusted the query selections on the column axis: a column corresponding to the second “year” parameter, with data for the default year 2010, has been appended to the table.

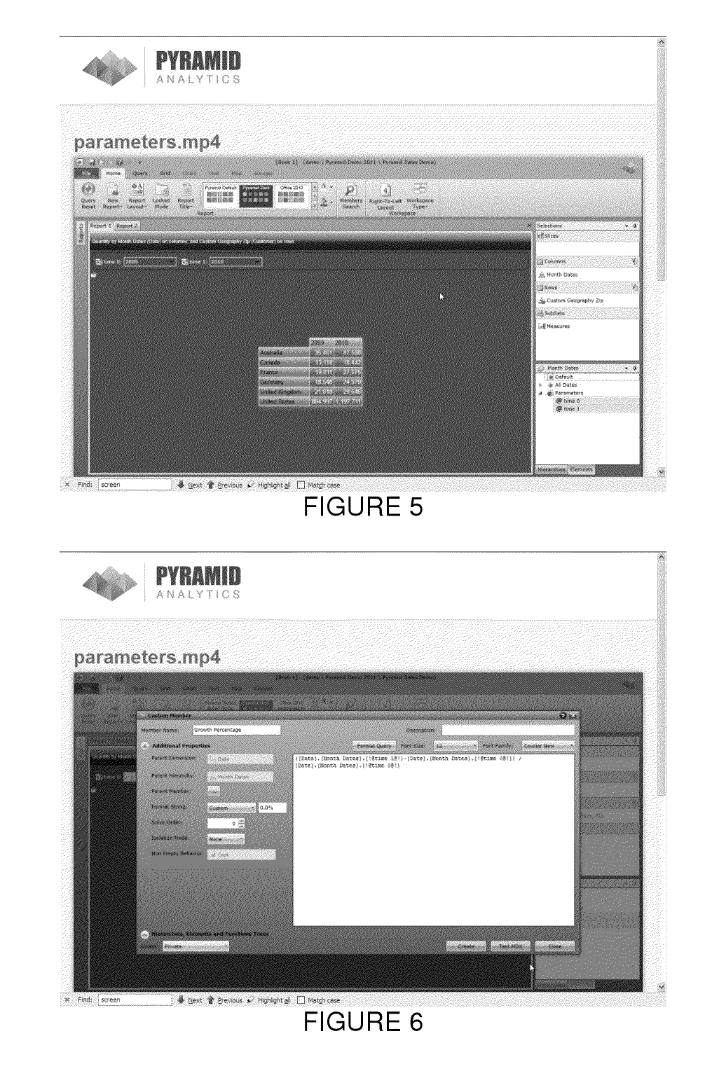

The results of FIG. 3 could be obtained conventionally by drilling down in the table of FIG. 1 to the year 2008. FIG. 5 shows a change of the display of the query that, although straightforward using the conventional methods discussed above, is trivially simple using the parameters of the present invention. In FIG. 5, the active value of the parameter has been edited to be “2009”. The first column of the table changes automatically to show data for 2009. Conventionally, such a table would have to be created from a conventional table with data for 2008 and 2010 by rolling back up to the table of FIG. 1, drilling down to “year” and dicing to just the years 2009 and 2010.

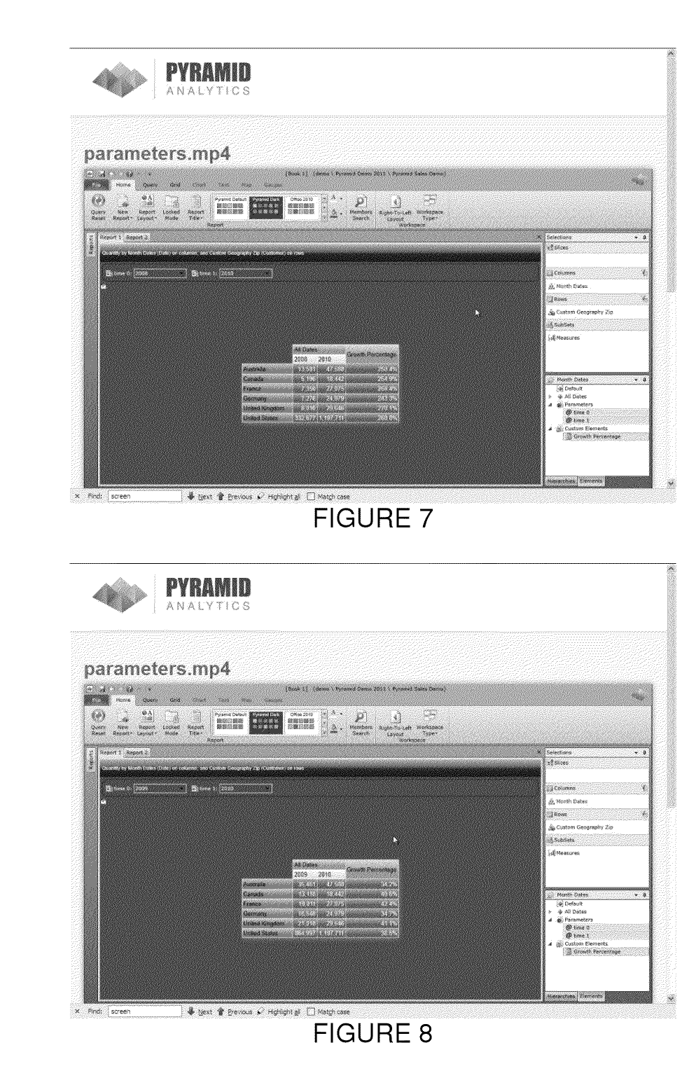

Returning to the table of FIG. 4, FIG. 6 shows a script for calculating growth percentages of the data of the table of FIG. 5 from 2008 to 2010. The parameter selections will feed into a calculation value that will be shown in the query when the script is executed. Executing this script gives the table of FIG. 7. The two parameters have adjusted the values that feed into the calculation. The same results could have been obtained conventionally by executing the script of FIG. 6 on a conventional table in which the “year” values were conventional static values rather than active values of parameters. But FIG. 8 shows that, now that the script of FIG. 6 has been associated with the table by being executed with the default values of the parameters, a table that shows growth percentage from 2009 to 2010 is obtained merely by editing the active value of the first parameter to “2009”. Conventionally, such a table would have to be created by rolling back up to the table of FIG. 1, drilling down to “year”, dicing to just the years 2009 and 2010, and executing the script on the new table.

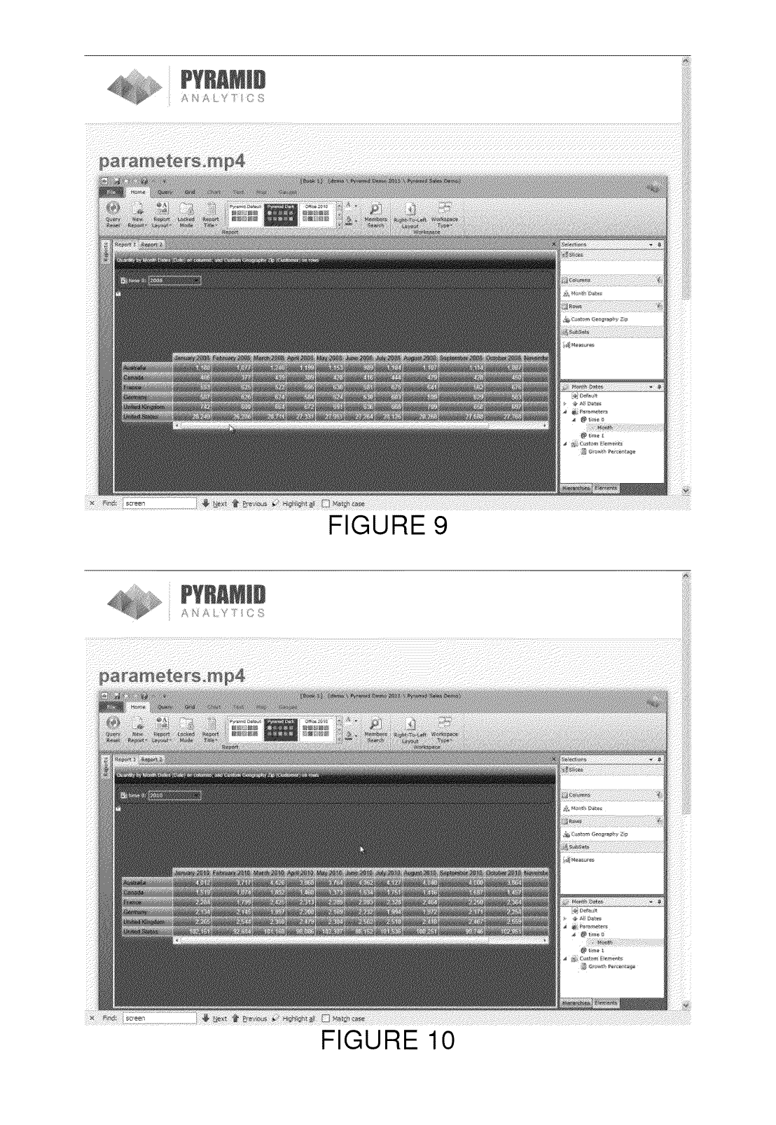

FIG. 9 shows the table of FIG. 3 with the “time” dimension displayed on the level of “month” subsets. FIG. 10 shows that merely editing the active value of the parameter to “2010” changes the table to a table of monthly values for the year 2010. Conventionally, such a table would have to be created by rolling back up to the table of FIG. 1, drilling down to “year”, dicing to the year 2010 and drilling down to “month”.

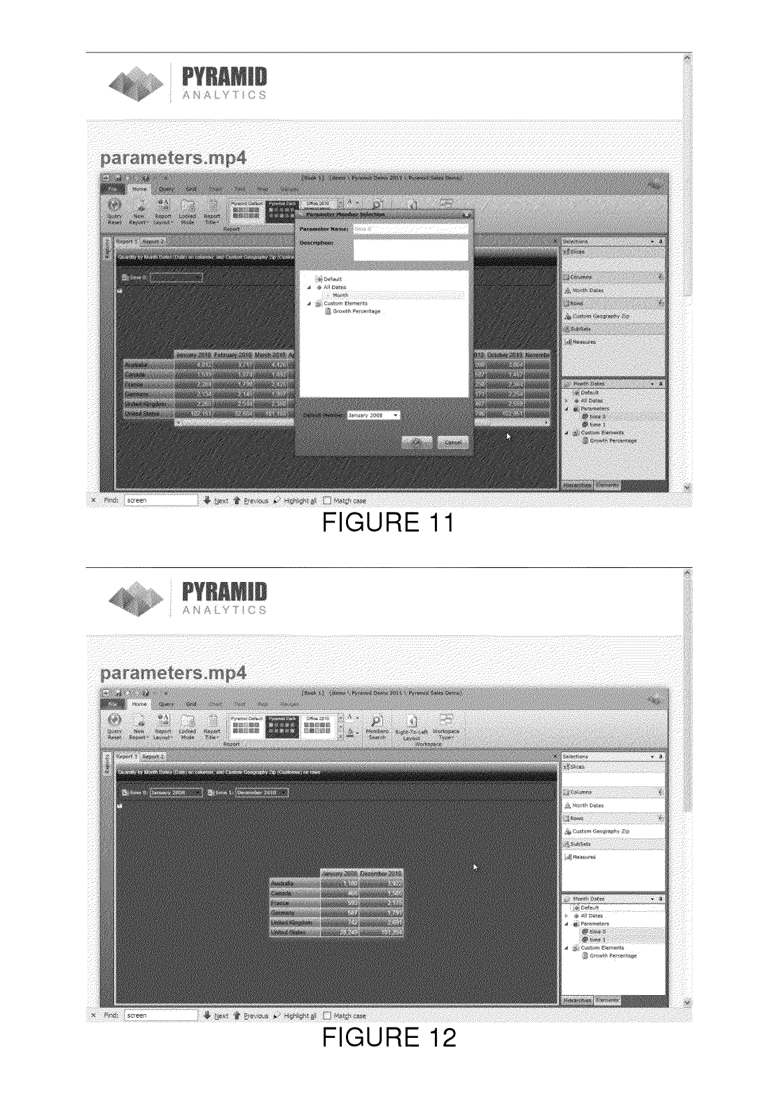

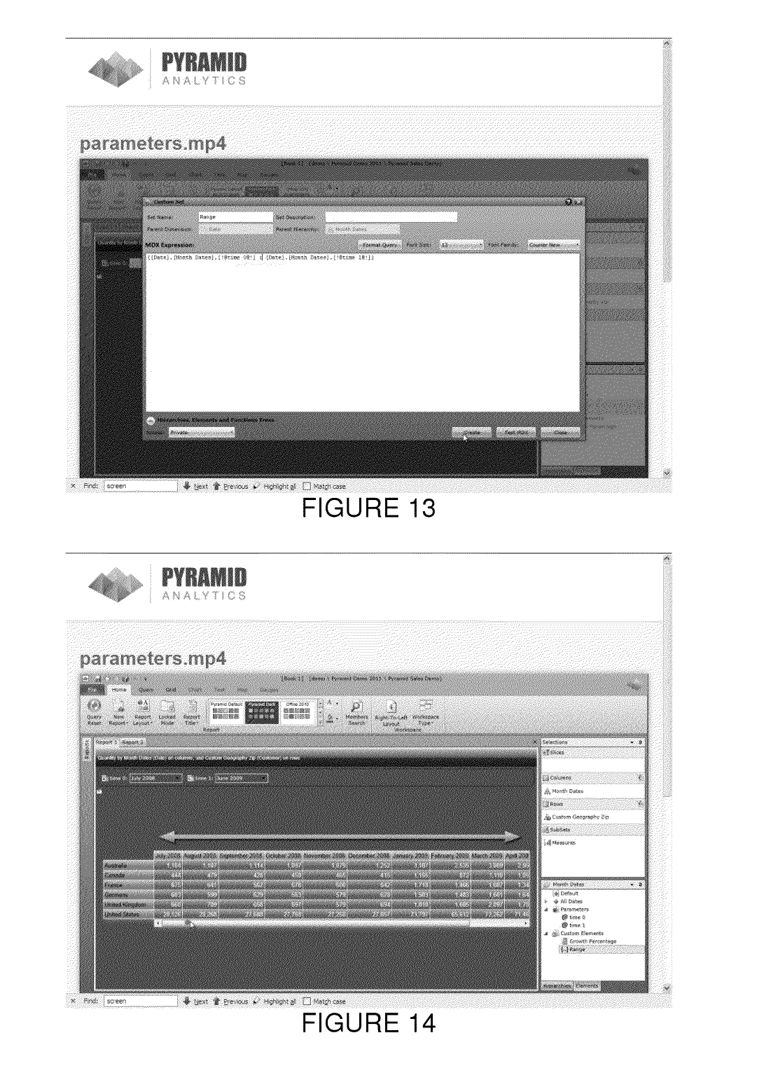

FIG. 11 shows the creation of a “month” parameter with the default value “January 2008”. FIG. 12 shows the table obtained by creating another “month” parameter with the default value “December 2010”. Such a table could be created conventionally from the table of FIG. 1 by drilling down to “month” and dicing the two months “January 2008” and “December 2010”. FIG. 13 shows a script for displaying a range of monthly values. Because the values of the script parameters time 08″ and “time 10” are parameterized sets of “time” elements rather than static sets of “time” elements, the two parameterized sets feed into the query function to determine the range of element subsets (months) to show in the resulting display of the query. If this script were executed on a conventional table, that resembles the, table of FIG. 12 but in which the column values were static rather than being active parameter values, a table showing the monthly values of the data for the months January 2008 through December 2010 would be obtained. The same would be obtained by executing the script on the table of FIG. 12. But, as shown in FIG. 14, merely editing the active values of the parameters to be “July 2008” and “June 2009” gives a table showing the monthly values of the data from July 2008 through June 2009. Conventionally, such a table would have to be created by rolling back up to the table of FIG. 1, drilling down to “month”, dicing to the months July 2008 and June 2009, and executing the script of FIG. 13.

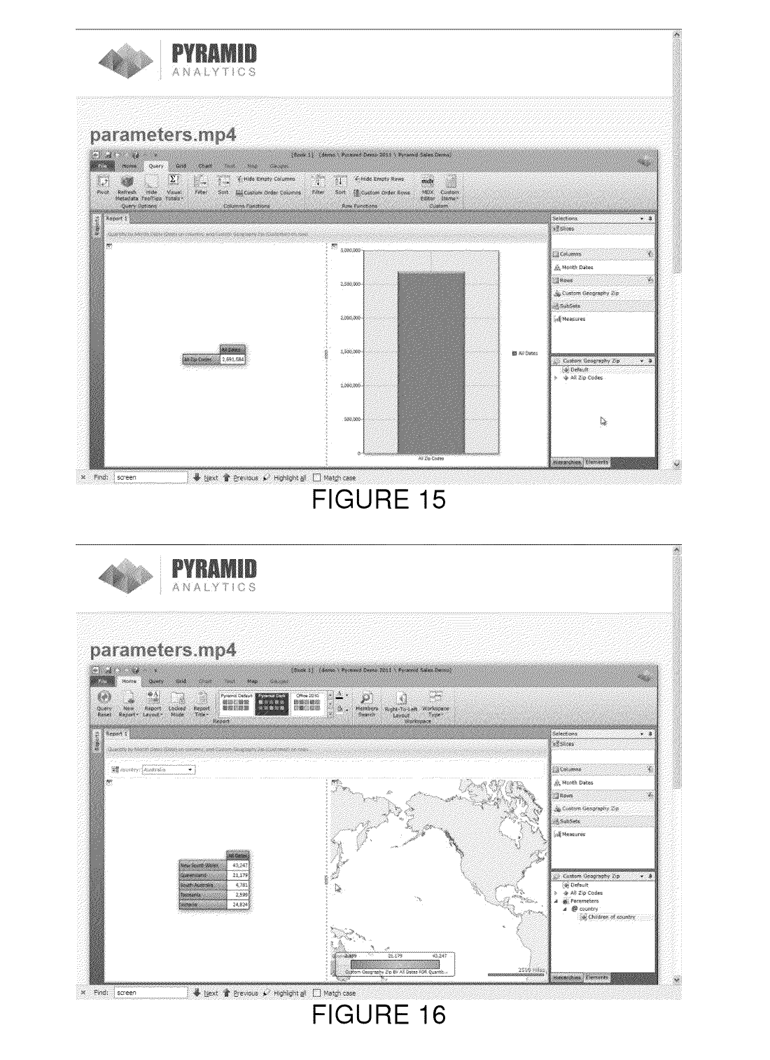

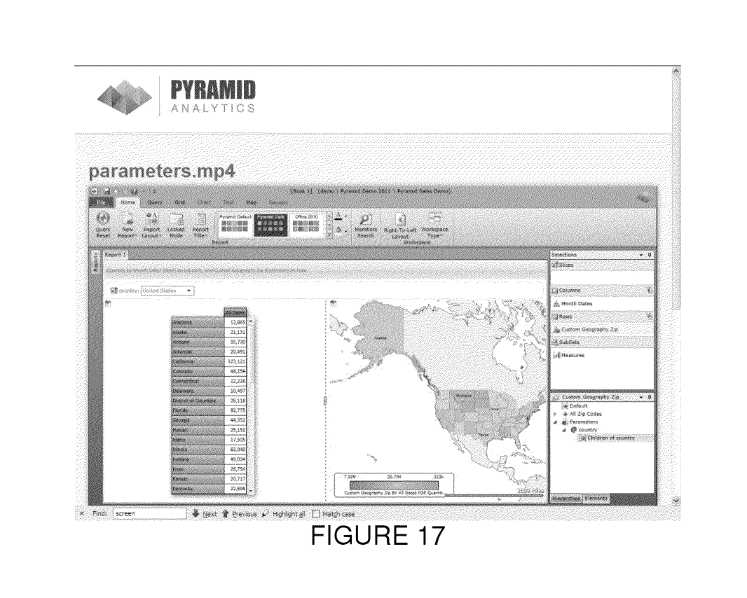

FIGS. 15-17 illustrate the application of the present invention to another query of the same database as the query of FIG. 1, for which the row elements have been grouped into sets on the level of zip codes and the column elements have been grouped into sets on the level of months. As in the previous query, the data are “quantities”. The table of FIG. 15 shows the data for countries vs. all dates. FIG. 16 shows the table after creating a “country” parameter whose default value is “Australia” with a display on the level of “states”. FIG. 17 shows that just editing the active parameter value to “United States” changes the table to a state-by-state table for the United States of America. To the right of the screen, the data of the table are displayed as a color-coded map.

Having seen these examples, those skilled in the art of coding multidimensional database management software and GUI software will readily understand how to modify such software in accordance with the present invention. Essentially, the modified software does “behind the back” of the user what the user him/herself could have done using conventional database management software but with considerably more effort.

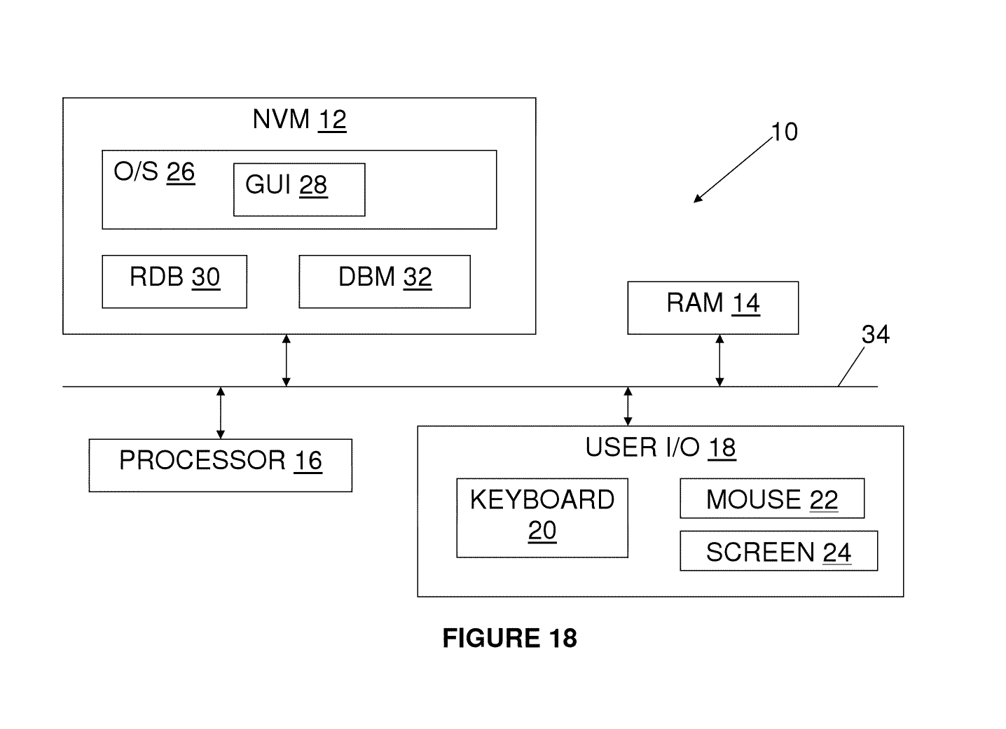

FIG. 18 is a high-level partial block diagram of a computer system 10 for presenting a database query according to the present invention. For clarity of illustration, only the components of system 10 that are directly relevant to the present invention are illustrated in FIG. 18. Device 10 includes a non-volatile memory (NVM) 12, a random access memory (RAM) 14, a processor 16 and user input/output devices 18 such as a keyboard 20, a mouse 22 and a screen 24, all communicating with each other via a bus 34. An operating system (O/S) 26 of the device is stored in non-volatile memory 12, as are a relational database (RDB) 30 and multidimensional database management (DBM) code 32. O/S 26 includes GUI code 28.

Under the control of O/S 24, processor 16 loads DBM code 32 into RAM 14 and executes DBM code 32 from RAM 14. DBM code is conventional DBM code, for extracting database queries from RDB 30, modified according to the principles of the present invention to interact with GUI code 28 to allow a user of system 10 to analyze the database queries as described above.

Non-volatile memory 12 is an example of a computer-readable storage medium bearing computer-readable code for implementing the interactive database query analysis methodology described herein. Other examples of such computer-readable storage media include read-only memories such as CDs bearing such code.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of presenting, on a computer system, a database query that has a plurality of dimensions, with each dimension including a plurality of elements, the method comprising:
(a) presenting, to a user of the computer system, an initial presentation of the database query;
(b) receiving, from said user, a selection of at least one set of the elements of a first one of the dimensions to transform into a respective parameter that has an active value;
(c) receiving, from said user, at least one instruction to modify the presentation of the database query, each said instruction being confined to providing an instance of said active value of a respective said parameter; and
(d) modifying said initial presentation in accordance with only said at least one instruction, thereby presenting a modified presentation of the database query to said user.

2. The method of claim 1, wherein said initial presentation and said modified presentation are presented on a graphical user interface (GUI) of the computer system.

3. The method of claim 1, wherein said selection and said at least one instruction are received via a graphical user interface (GUI) of the computer system.

4. The method of claim 1, wherein said one dimension is an explicit dimension of the database query.

5. The method of claim 1, wherein said one dimension is an implicit dimension of the database query.

6. The method of claim 1, further comprising:
(e) prior to receiving said at least one instruction: receiving from said user, a function of said at least one parameter to use to modify the presentation of the database query, said modifying of said initial presentation then being in accordance with output of said function.

7. The method of claim 6, wherein said function produces said output at least in part by operating on said respective data of said n-tuples that includes elements of at least a portion of said at least one set that is selected by said user to transform into said at least one parameter.

8. The method of claim 6, wherein said output of said function includes at least one more set of the elements of a second one of the dimensions.

9. The method of claim 8, wherein said second dimension is identical to said first dimension.

10. A computer-readable storage medium having non-transient computer-readable code embodied on the computer-readable storage medium, the computer-readable code for presenting, on a computer system, a database query that has a plurality of dimensions, with each dimension including a plurality of elements, the computer-readable code comprising:
(a) program code for presenting, to a user of the computer system, an initial presentation of the database query;
(b) program code for receiving, from said user, a selection of at least one set of the elements of a first one of the dimensions to transform into a respective parameter that has an active value;
(c) program code for receiving, from said user, at least one instruction to modify the presentation of the database query, each said instruction being confined to providing an instance of said active value of a respective said parameter; and
(d) program code for modifying said initial presentation in accordance with only said at least one instruction, thereby presenting a modified presentation of the database query to said user.
